(19) United States
(12) Patent Application Publication
(10) Pub. No.: US 2019/0138621 A1
(43) Pub. Date: May 9, 2019

(54) HIGH-SPEED SECURE VIRTUAL FILE SYSTEM

(71) Applicant: FHOOSH, Inc., La Jolla, CA (US)

(72) Inventors: Eric TOBIAS, La Jolla, CA (US); William EIGNER, La Jolla, CA (US); Linda EIGNER, La Jolla, CA (US); Charles KAHLE, Escondido, CA (US); William BONNEY, San Diego, CA (US); Gary SCHNEIR, Carlsbad, CA (US); Anthony IASI, San Diego, CA (US); John TYNER, San Diego, CA (US)

(21) Appl. No.: 15/806,058

(22) Filed: Nov. 7, 2017

(51) Int. Cl. G06F 17/30; G06F 21/62; H04L 9/30; G06F 3/06

(52) U.S. Cl. CPC G06F 17/30233; G06F 21/6218; G06F 2221/2107; G06F 3/0667; H04L 9/30

(57) ABSTRACT

A system for storing data with a virtual file system includes: means for receiving a file; means for disassembling the file into fragments; means for encrypting the fragments; means for mapping the fragments to different storage locations in the virtual file system; means for transmitting the encrypted file fragments to the different storage locations in the virtual file system; and means for storing the encrypted file fragments to the different storage locations in the virtual file system.

### CROSS-REFERENCE TO RELATED APPLICATION(S)

This application is related to U.S. patent application Ser. No. 14/863,294, filed on Sep. 23, 2015, and U.S. patent application Ser. No. 14/061,736, filed on Oct. 23, 2013, now U.S. Pat. No. 9,665,638, granted on May 30, 2017, the disclosures of which are incorporated herein in their entireties by reference.

### BACKGROUND

### 1. Field

A high-speed secure virtual file system that provides encryption benefits through ordinary file system commands such as commands for reading and writing files is provided.

### 2. Related Art

Unless otherwise indicated herein, the materials described in this section are not prior art to the claims in this application and are not admitted to be prior art by inclusion in this section.

A virtual file system (VFS) is an abstraction layer on top of a more concrete file system inherent to a particular device. Virtual File Systems have been available for years and provide many types of interfaces to the underlying file system. Currently, there are a number of offerings that allow a user to store data to a cloud- based service through a VFS in a way that does not require the use of special utilities. s3fs-fuse (https://github.com/s3fs-fuse/) is one such offering. There are offerings for Microsoft's Azure service as well, although these are not as readily available/supported. Additionally, the idea of a write-only asymmetrically-encrypted file system has also been contemplated in the WOCFS (Write Only encrypted File System) (http://www.arthy.org/wocfs). Finally, a cloud-based encrypted file storage, i.e., Keybase, (https://keybase.io/docs/kbfs/) is offered for sharing between users who may not know each other.

FIG. 1 is a diagram illustrating a system 100 including conventional access to various file systems 100. Referring to FIG. 1, user applications 110 separately integrate with local storage media 130 and/or cloud based file systems 140, 150. For each of the cloud-based file system offerings (e.g., S3, Azure) mentioned above, security features (e.g., encryption, monitoring, etc.) are not available (see, for example, the NOTES section of s3fs-fuse accessible at https://www.systutorials.com/docs/linux/man/1-s3fs/for a description of the limitations). In the case of WOCFS, aside from the age of the implementation and lack of update since 2011, no support is provided for a cloud-based backing, redundancy, or read (in addition to write) access. And while Keybase is mentioned due to its seemingly obvious relation to the FHOOSH-based file system, Keybase is primarily a method for users to store and share files and also requires the use of Keybase's servers.

Thus, with conventional file systems, no security/encryption is provided except the security/encryption that may be provided by each individual application in the absence of full disk encryption on storage devices. Conventional devices are attackable at the device level with all of the vulnerabilities at that level. All of them can be defeated by gaining root to the device.

### SUMMARY

Apparatuses and methods for providing a virtual file system having encryption benefits are provided.

According to various aspects there is provided a method for storing data with a virtual file system. In some aspects, the method may include: receiving, by a processor, a file; disassembling, by an encryption engine, the file into fragments; encrypting, by the encryption engine, the fragments; mapping, by the encryption engine, the fragments to different storage locations in the virtual file system; transmitting, by the processor, the encrypted file fragments to the different storage locations in the virtual file system; and storing the encrypted file fragments to the different storage locations in the virtual file system.

According to various aspects there is provided a method for accessing data with a virtual file system. In some aspects, the method may include: receiving, by a processor, a request to access a file; determining, by the processor, whether the request is from an authorized user; in response to determining that the request is from an authorized user: retrieving, by the processor, encrypted fragments of the file from different storage locations of the virtual file system based on mapping information previously generated by an encryption engine of the fragments to the different storage locations in the virtual file system; receiving, by the processor, the encrypted file fragments from the different storage locations in the virtual file system; decrypting, by the encryption engine, the encrypted file fragments; and reassembling, by the encryption engine, the decrypted file fragments into the requested file.

According to various aspects there is provided a non-transitory computer readable medium. In some aspects, the non-transitory computer readable medium may include instructions for causing one or more processors to perform operations including: receiving, by a processor, a file; disassembling, by an encryption engine, the file into fragments; encrypting, by the encryption engine, the fragments; mapping, by the encryption engine, the fragments to different storage locations in the virtual file system; transmitting, by the processor, the encrypted file fragments to the different storage locations in the virtual file system; and storing the encrypted file fragments to the different storage locations in the virtual file system.

According to various aspects there is provided a non-transitory computer readable medium. In some aspects, the non-transitory computer readable medium may include instructions for causing one or more processors to perform operations including: receiving, by a processor, a request to access a file; determining, by the processor, whether the request is from an authorized user; in response to determining that the request is from an authorized user: retrieving, by the processor, encrypted fragments of the file from different storage locations of the virtual file system based on mapping information previously generated by an encryption engine of the fragments to the different storage locations in the virtual file system; receiving, by the processor, the encrypted file fragments from the different storage locations in the virtual file system; decrypting, by the encryption engine, the encrypted file fragments; and reassembling, by the encryption engine, the decrypted file fragments into the requested file.

According to various aspects there is provided a system for storing data with a virtual file system. In some aspects, the system may include: means for receiving a file; means for disassembling the file into fragments; means for encrypting the fragments; means for mapping the fragments to different storage locations in the virtual file system; means for transmitting the encrypted file fragments to the different storage locations in the virtual file system; and means for storing the encrypted file fragments to the different storage locations in the virtual file system.

According to various aspects there is provided a system for accessing data with a virtual file system. In some aspects, the system may include: means for receiving a request to access a file; means for determining whether the request is from an authorized user; in response to determining that the request is from an authorized user: means for retrieving encrypted fragments of the file from different storage locations of the virtual file system based on mapping information previously generated by means for generating mapping information of the fragments to the different storage locations in the virtual file system; means for receiving the encrypted file fragments from the different storage locations in the virtual file system; means for decrypting the encrypted file fragments; and means for reassembling the decrypted file fragments into the requested file.

Other features and advantages should be apparent from the following description which illustrates by way of example aspects of the various teachings of the disclosure.

### BRIEF DESCRIPTION OF THE DRAWINGS

Aspects and features of the various embodiments will be more apparent by describing examples with reference to the accompanying drawings, in which:

FIG. 1 is a diagram illustrating a system including conventional access to various file systems;

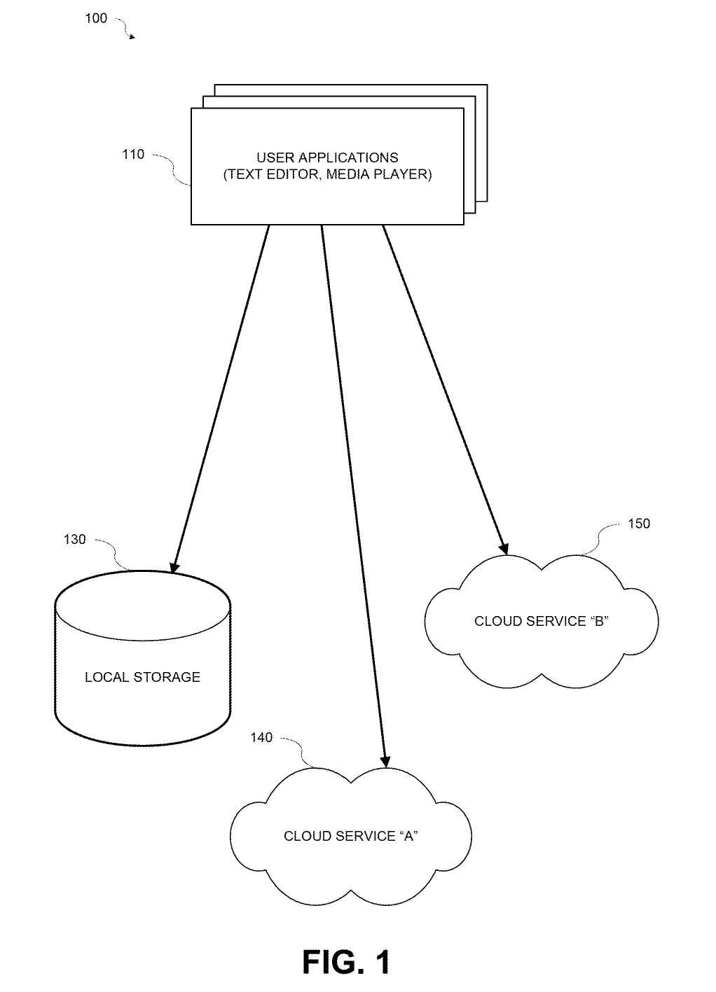

FIG. 2 is a diagram illustrating a system including a virtual file system according to various aspects of the present disclosure;

FIG. 3 is a diagram illustrating a system including a virtual file system utilizing a public key in accordance with various aspects of the present disclosure;

FIG. 4 is a diagram illustrating a system including a virtual file system utilizing a public key and a private key in accordance with various aspects of the present disclosure:

FIG. 5 is a flowchart of a method for storing data with the virtual file system in accordance with various aspects of the present disclosure;

FIG. 6 is a flowchart of a method for accessing data with the virtual file system in accordance with various aspects of the present disclosure; and

FIG. 7 is a block diagram illustrating wired or wireless system in accordance with various aspects of the present disclosure.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

In conventional implementation, when users access encrypted files using non-full-disk-encryption schemes with the intent to read or modify such files, the files must be decrypted to perform these actions and then re-encrypted when work is completed Various aspect of the present disclosure provide encryption and protection independent of the underlying device and extend a single unified protection scheme across the entire virtual file system, thus providing device independent data protection. The disclosed high-speed secure virtual file system (VFS) utilizes an encryption engine and can store files in an encrypted state and provide either write-only access (for later on or off-line read access) or full read/write access in a way that prevents unencrypted data from ever needing to be stored to disk in an insecure/unencrypted state. For example, a file may be encrypted and stored remotely in a cloud-based system at a remote server, with portions of the file stored in separate locations with separate encryption to minimize the risk of unauthorized access to one portion of the information. Fields of data in the file may also be separately encrypted with separate encryption keys and separately stored in separate data stores, databases, or in separate database tables, to minimize the amount of information which could be disclosed by the unauthorized access to a single encryption key or a single database, or database table. The file encryption/decryption and disassociation is more fully described in related U.S. patent application Ser. No. 14/863,294, titled “Systems and Methods for Diffracted Data Retrieval,” the disclosure of which is incorporated herein in its entirety by reference.

The disclosed VFS is further able to store/access files in a redundant manner using any combination of local or cloud-based storage services and monitor accesses to these files to detect intrusion and/or to disable access to files after a period of time without user interaction in a way that does not require the user to use special tools for encryption and decryption.

In accordance with various aspects of the present disclosure, dissociative properties, for example but not limited to the separate storage processes previously described, may be integrated to disperse encrypted portions of users' files across multiple locations within a storage medium and across multiple storage media. For example, the dispersed encrypted portions of the files may be stored on major cloud platforms, for example but not limited to, AWS, Azure, or the like, cloud folders, for example but not limited to, Box, Dropbox, iCloud, Google Drive, OneDrive, or the like, or on local storage. This may be done in a way that duplicates data across these locations through definable virtual cryptological containers, providing reliability in cases where one or more locations are inaccessible or corrupted.

This may include simple data duplication as well as error-correcting codes that can reconstruct missing elements under certain conditions. Access to users' data may also be monitored/mediated in a way that detects and prevents access by a third-party and also allows the data to be made inaccessible after a period of inactivity by the user. Upon detection of attempted, unauthorized access, the data may be moved (while maintaining it in a secure, encrypted state) to another storage location to avoid threats such as various implementations of a class of malware commonly known as “ransomware” in that files are maliciously encrypted without the owner's knowledge or consent and then the key for decryption is held for ransom.

Unlike full-disk encryption, files are not available to every user of the system once they have been unlocked. When paired with a remote key server, the VFS may be configured to transparently authenticate the user and retrieve the corresponding key(s) on a per-file and/or per-access basis. Thus, if a user opens an encrypted file from the VFS, and the account is subsequently compromised by an attacker, the attacker does not automatically gain access to the encrypted data unless the attacker also compromises the authentication token/scheme in place for the file. Similarly, even if the attacker gains the highest-level administrator access to the system, data within the VFS remains secure because access to data within the file system still relies on a separate authentication with the remote key server.

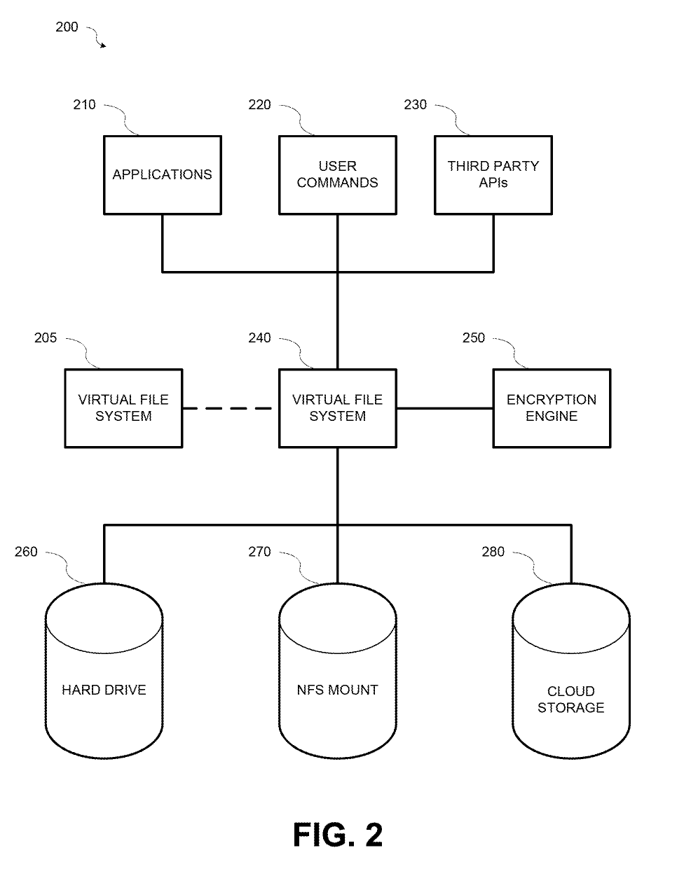

FIG. 2 is a diagram illustrating a system 200 including a VFS in accordance with various aspects of the present disclosure. The system may include a processor 205, VFS 240, and encryption engine 250, and a plurality of storage devices, for example but not limited to, local storage, for example, hard drives 260 and/or Network File System (NFS) mounts 270, and as well as cloud storage 280 provided by cloud service providers, for example but not limited to, Amazon S3 and Azure as well as cloud folders, for example but not limited to, Box, Dropbox, iCloud, Google Drive, OneDrive, or the like. The system 200 may accept inputs from applications 210, user commands 220, and third-party application programming interfaces (APIs) 230. The processor 205 may run applications 210, accept input from user commands 220 and third-party APIs 230, and may implement the encryption engine 250 and the VFS 240.

The encryption engine 250 may store files in an encrypted state and provide either write-only access or full read/write access. The encryption engine 250 may interface with the VFS 240 to store files remotely in a cloud-based system at a remote server, with portions of the file stored in separate locations with separate encryption. Alternatively or additionally, portions of the file may be stored in separate locations on local storage (e.g., hard disk drives 260 and/or NFS mounts 270) with separate encryption.

In accordance with various aspects of the present disclosure, a public/private key infrastructure (PKI) may be integrated as one optional means to determine that the request to write a file (data) to the VFS is from an authorized user. In various embodiments, writing a file to the VFS requires the presentation of a public key.

In accordance with various aspects of the present disclosure, a public/private key infrastructure (PKI) may be integrated as one optional means to determine that the request to view or modify a file (data) in the VFS is from an authorized user. In various embodiments, viewing or modifying a file (data) in the VFS requires the presentation of a private key.

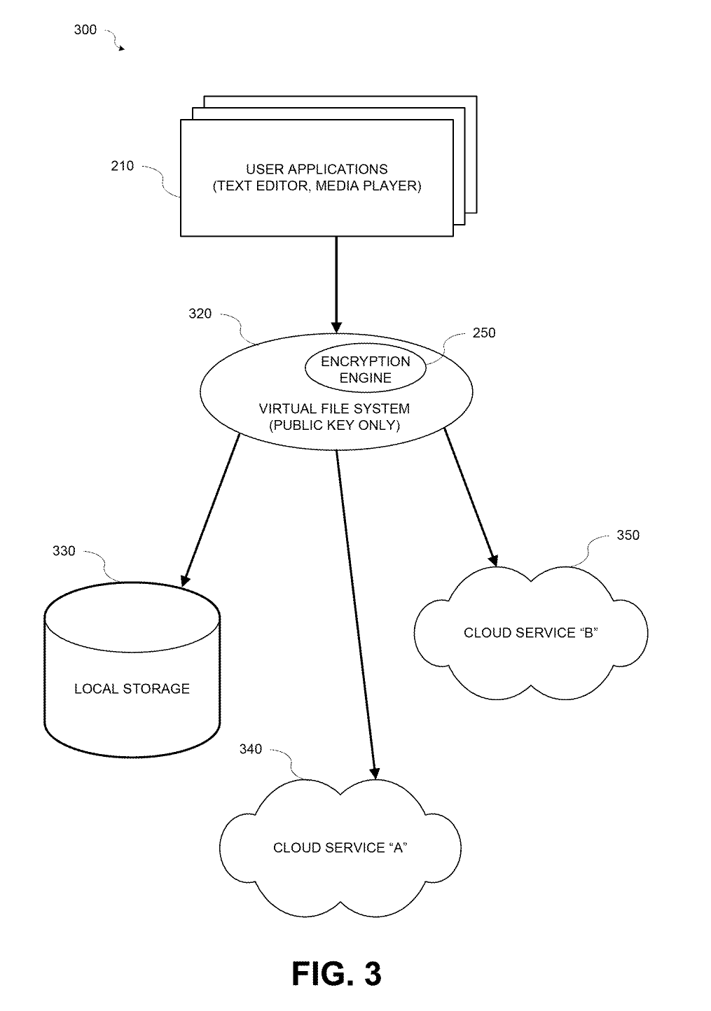

FIG. 3 is a diagram illustrating a system 300 including a VFS 320 utilizing a public key in accordance with various aspects of the present disclosure. As illustrated in FIG. 3, the system 300 may include the VFS 320, and a plurality of storage devices, for example but not limited to, local storage 330 (e.g., hard drives 260 and/or Network File System (NFS) mounts 270) and as well as cloud storage provided by cloud service providers 340, 350, for example but not limited to, Amazon S3 and Azure. The system 300 may accept inputs from applications 210, user commands 220, and third-party application programming interfaces (APIs) 230. The VFS 320 may include the encryption engine 250.

User applications do not need special code to integrate with external storage media or to implement their own security. User data may be fragmented and dispersed over a variety of storage media. As illustrated in FIG. 3, only the public key is available. Data may be written (possibly by many writers) but not read.

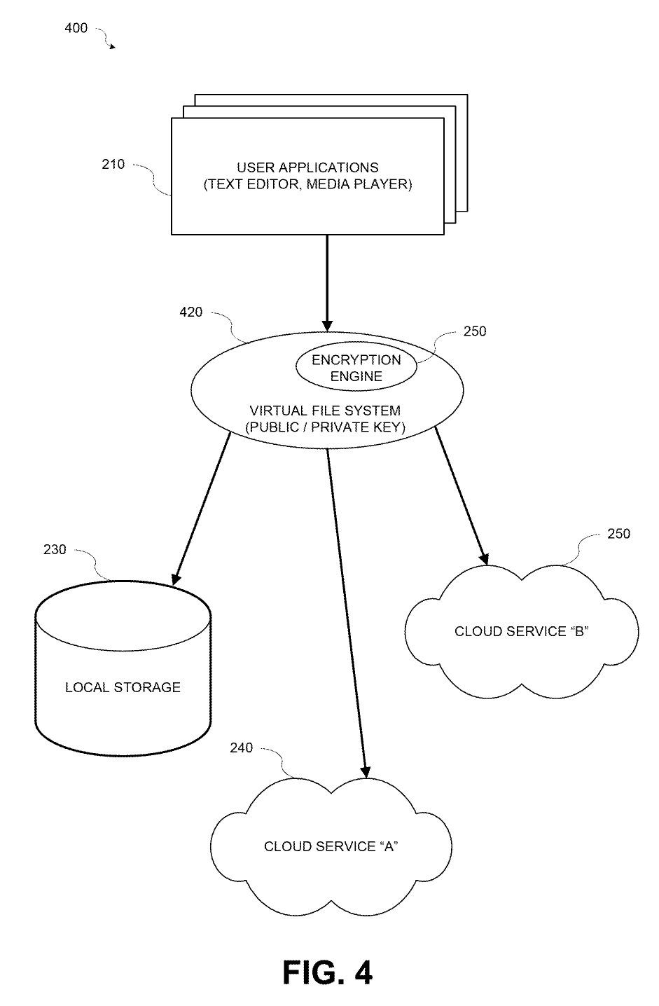

FIG. 4 is a diagram illustrating a system 400 including a VFS 420 utilizing a public key and a private key in accordance with various aspects of the present disclosure. As illustrated in FIG. 4, the system 400 may include the VFS 420, and a plurality of storage devices, for example but not limited to, local storage 430 (e.g., hard drives 260 and/or Network File System (NFS) mounts 270) and as well as cloud storage provided by cloud service providers 440, 450, for example but not limited to, Amazon S3 and Azure. The system 400 may accept inputs from applications 210, user commands 220, and third-party application programming interfaces (APIs) 230. The VFS 420 may include the encryption engine 250.

With public and private key, files can be read and written. With the ability to decrypt the data, the VFS 420 is able to re-encrypt fragments under different keys in different locations in response to threats detected while monitoring. In accordance with various aspects of the present disclosure, a secure key platform supports active key rotation that internally protects stored credentials from hackers who attempt to use old keys. The secure key platform is able to rotate data store credentials as frequently as necessary (e.g., every minute). Additional description is contained in U.S. application Ser. No. 15/411,888, the disclosure of which is incorporated herein in its entirety by reference.

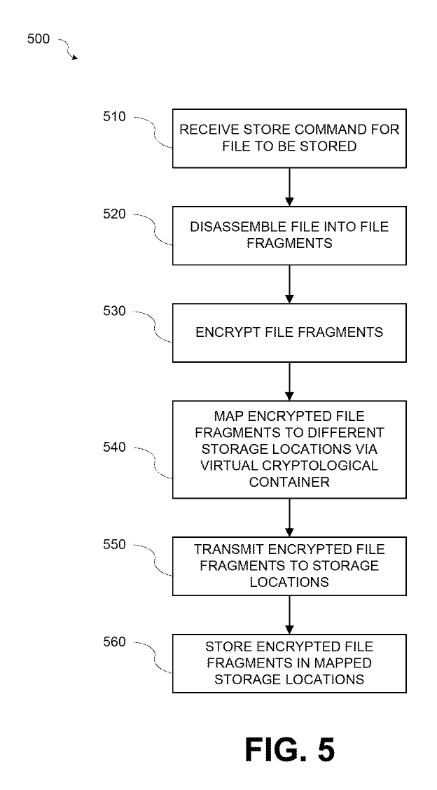

FIG. 5 is a flowchart of a method 500 for storing data with the VFS in accordance with various aspects of the present disclosure. Referring to FIG. 5, at block 510 a store command may be received for a file to be stored with the VFS. For example, a command to save a file may be received from a local computer. At block 520, the file may be disassembled into file fragments at the local computer. For example, the encryption engine 250 may disassemble the file into fragments of various different sizes. At block 530, each file fragment may be separately encrypted. For example, each file fragment may be separately encrypted by the encryption engine 250.

At block 540, the encrypted file fragments may be mapped to storage locations via a virtual cryptological container or other data map for the file. For example, the encrypted fragments of users' files may be mapped by the encryption engine 250 to storage locations dispersed across multiple locations within a storage medium and/or across multiple storage media. The encryption engine 250 may store mapping information of the encrypted file fragments in the virtual cryptological container or other data map for the file. In accordance with various aspects of the present disclosure, the encryption engine 250 may generate, encrypt, and store a data map that includes at least a portion of the information required to retrieve and reconstruct the decomposed data object (e.g., decomposition function, obfuscated record locators, encryption keys, and storage locations). Alternately or in addition, the encryption engine 250 can perform one or more computations to dynamically derive (e.g., when retrieving the data object) at least a portion of the information required to retrieve and reconstruct the disassembled file.

In accordance with various aspects of the present disclosure, the encryption engine 250 may store encrypted file fragments without any logical connection to other encrypted file fragments. The encryption engine 250 may create and store an encrypted mapping and use the encrypted mapping to re-associate the encrypted file fragments previously stored without any logical connection.

In accordance with various aspects of the present disclosure, the encryption engine 250 may create a manifest for blocks of encrypted data fragments for a user of the VFS and encrypt the manifests using a unique secret key for each user. The encrypted manifest may be transmitted, for example by the processor, to an intended user followed by a block of encrypted data fragments. The intended user may decrypt the encrypted data fragments using data contained in the encrypted manifest. Additional description is contained in U.S. application Ser. No. 15/622,033, the disclosure of which is incorporated herein in its entirety by reference.

At block 550, the encrypted file fragments may be transmitted to the storage locations mapped via the virtual cryptological container or other data map. For example, the encryption engine 250 may interface with the VFS 240 to store files remotely in a cloud-based system at a remote server, with portions of the file stored in separate locations with separate encryption. Alternatively or additionally, portions of the file may be stored in separate locations on local storage. At block 560, the encrypted file fragments may be stored in the storage locations mapped by the virtual cryptological container or other data map.

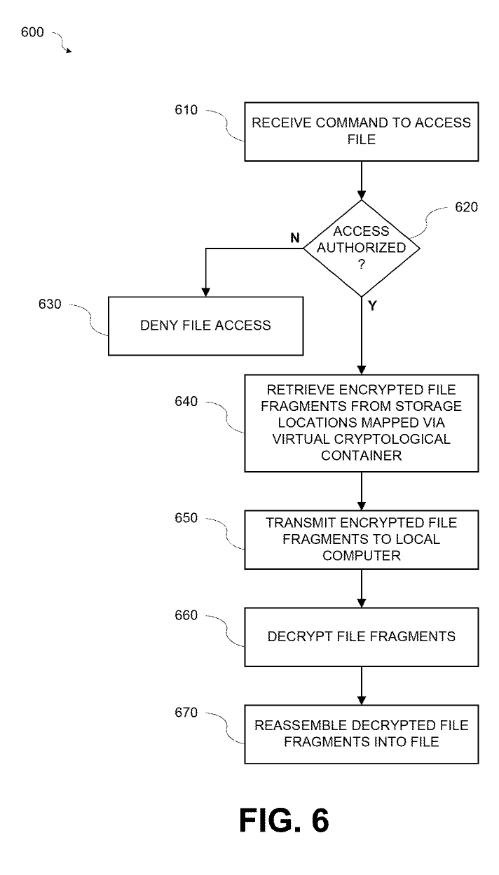

FIG. 6 is a flowchart of a method 600 for accessing data with the VFS in accordance with various aspects of the present disclosure. Referring to FIG. 6, at block 610 a command may be received requesting retrieval of a file stored with the VFS. For example, a command to retrieve a file may be received from a local computer.

At block 620, it may be determined whether access to the file is authorized. For example, a processor may determine whether a request has been made by an authorized user. Individual files may not be available to every user of the system in which case the file will not be unlocked. When paired with a remote key server, the VFS may be configured to transparently authenticate the user and retrieve the corresponding key(s) on a per-file and/or per-access basis. Access to users' data may be monitored/mediated to detect and prevent access by an unauthorized user or a third-party and may also allow the data to be made inaccessible after a period of inactivity by the user.

In response to determining that access to the file is not authorized (620-N), at block 630 access to the file is denied. Upon detection of repeated attempted unauthorized access, the data may be moved (while maintaining it in a secure, encrypted state) to another storage location. For example, when the processor determines that repeated unauthorized access attempts have occurred, the processor may cause the encrypted file fragments to be moved to alternate storage locations and update the mapping information in the virtual cryptological container. Alternatively or additionally, the file may be “re-keyed” to re-encrypt the file using a different encryption key. In accordance with various aspects of the present disclosure, a secure key platform supports active key rotation that internally protects stored credentials from hackers who attempt to use old keys. The secure key platform is able to rotate data store credentials as frequently as necessary (e.g., every minute). In response to determining that access to the file is authorized (620-Y), at block 640 encrypted file fragments may be retrieved from the different storage locations mapped via the virtual cryptological container or other data map for the file. For example, the processor may cause the encrypted file fragments to be retrieved from storage locations based on the mapping information contained in the virtual cryptological container or other data map.

At block 650, the encrypted file fragments may be received by the local computer from the different storage locations. For example, the processor may cause the local computer to receive the encrypted file fragments from the various mapped storage locations. At block 660, the file fragments may be decrypted. For example, the encryption engine 250 may decrypt each of the encrypted file fragments. At block 670, the decrypted file fragments are reassembled into the requested file. For example, the encryption engine 250 may reassemble each of the decrypted file fragments into the file.

The methods 500 and 600, respectively, may be embodied on a non-transitory computer readable medium, for example, but not limited to, a memory or other non-transitory computer readable medium known to those of skill in the art, having stored therein a program including computer executable instructions for making a processor, computer, or other programmable device execute the operations of the methods.

The disclosed VFS elevates the current state of the art by incorporating the benefits of encryption to ordinary system functions in such a way as to make those benefits transparent and accessible to a wide variety of applications that may otherwise not be able to take advantage of secure operations. Additional benefits enabled by this invention include, but are not limited to, the following:
The disclosed VFS is able to log all commands (such as copy, read, write, move, etc.) into a secure audit log that can be used to identify out-of-norm behaviors and threats by maintaining a full record of activity for subsequent risk scoring.
The disclosed VFS can be configured to filter, limit, or block certain commands based on rules that identify any number of scenarios such as file size, path location of file, metadata within the file.
The disclosed VFS can incorporate a load balancer that will redirect command traffic to a clustered device to enable command completion in the case of high demand or for resiliency when parts of the infrastructure go down.
Access to the disclosed VFS can be restricted to specific users or devices with specific credentials. All other users will automatically be routed to the default file system.
The disclosed VFS can be mapped via a Virtual Cryptological Container to access specific parts of a data stores or clouds.
A set of virtual file systems can be organized into a cascading VFS where additional credentials are required to access more restricted VFS mappings. A user with high access privileges may be able to use a VFS that is normally hidden from other users.
The interface API to a VFS can be programmatically mapped to facilitate integration of disparate systems that ordinarily are not able to communicate with each other. For example, one third-party system may use the command “save as” and other system may use the command “pseudo cp” to perform the same operation. The VFS will recognize all interchangeable commands.
Access credentials and keys can be stored on a Remote Server such that the VFS can only be accessed once a user is authenticated from a remote system separated from the VFS location.

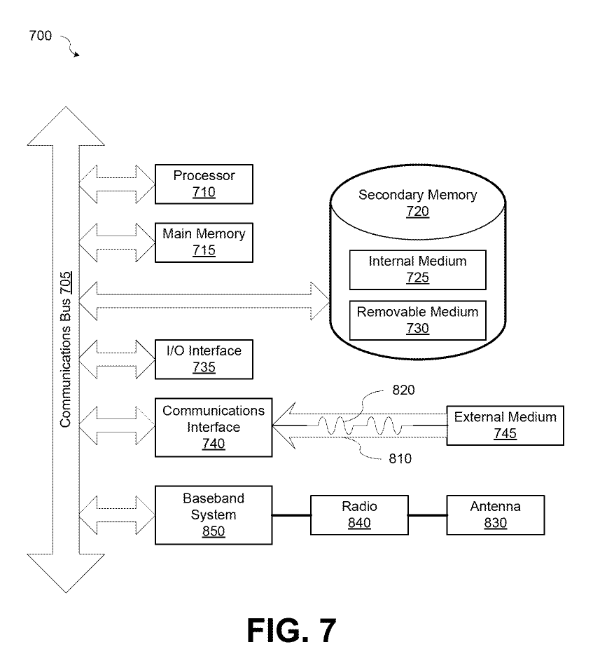

FIG. 7 is a block diagram illustrating wired or wireless system 700 in accordance with various aspects of the present disclosure. In accordance with various aspects of the present disclosure, the system 700 may be used in the implementation of the VFS.

In various embodiments, the system 700 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 700 may include one or more processors, such as processor 710. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 710.

The processor 710 may be connected to a communication bus 705. The communication bus 705 may include a data channel for facilitating information transfer between storage and other peripheral components of the system 700. The communication bus 705 may further provide a set of signals used for communication with the processor 710, including a data bus, address bus, and control bus (not shown). The communication bus 705 may be any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPM”). IEEE 696/S-100, and the like.

System 700 may include a main memory 715 and may also include a secondary memory 720. The main memory 715 may provide storage of instructions and data for programs executing on the processor 710. The main memory 715 is typically semiconductor-based memory such as dynamic random-access memory (“DRAM”) and/or static random-access memory (“SRAM”). Other semiconductor-based memory types include, for example, synchronous dynamic random-access memory (“SDRAM”), Rambus dynamic random-access memory (“RDRAM”), ferroelectric random-access memory (“FRAM”), and the like, including read only memory (“ROM”).

The secondary memory 720 may optionally include an internal memory 725 and/or a removable storage medium 730, for example a floppy disk drive, a magnetic tape drive, a compact disc (“CD”) drive, a digital versatile disc (“DVD”) drive, etc. The removable storage medium 730 is read from and/or written to in a well-known manner Removable storage medium 730 may be, for example, a floppy disk, magnetic tape, CD, DVD, SD card, etc.

The removable storage medium 730 is a non-transitory computer readable medium having stored thereon computer executable code (i.e., software) and/or data. The computer software or data stored on the removable storage medium 730 is read into the system 700 for execution by the processor 710.

In alternative embodiments, the secondary memory 720 may include other similar means for allowing computer programs or other data or instructions to be loaded into the system 700. Such means may include, for example, an external storage medium 745 and a communication interface 740. Examples of external storage medium 745 may include an external hard disk drive or an external optical drive, or and external magneto-optical drive.

Other examples of secondary memory 720 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are the removable storage medium 730 and a communication interface, which allow software and data to be transferred from an external storage medium 745 to the system 700.

System 700 may also include an input/output (“I/O”) interface 735. The I/O interface 735 facilitates input from and output to external devices. For example, the I/O interface 735 may receive input from a keyboard or mouse and may provide output to a display. The I/O interface 735 is capable of facilitating input from and output to various alternative types of human interface and machine interface devices alike.

System 700 may also include a communication interface 740. The communication interface 740 allows software and data to be transferred between system 700 and external devices (e.g. printers), networks, or information sources. For example, computer software or executable code may be transferred to system 700 from a network server via communication interface 740. Examples of communication interface 740 include a modem, a network interface card (“NIC”), a wireless data card, a communications port, an infrared interface, and an IEEE 1394 fire-wire, just to name a few.

Communication interface 740 implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 740 are generally in the form of electrical communication signals 820. The electrical communication signals 820 are preferably provided to communication interface 740 via a communication channel 810. In various embodiments, the communication channel 810 may be a wired or wireless network, or any variety of other communication links. Communication channel 810 carries the electrical communication signals 820 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 715 and/or the secondary memory 720. Computer programs can also be received via communication interface 740 and stored in the main memory 715 and/or the secondary memory 720. Such computer programs, when executed, enable the system 700 to perform the various functions of the present invention as previously described.

In this disclosure, the term “computer readable medium” is used to refer to any non-transitory computer readable storage media used to provide computer executable code (e.g., software and computer programs) to the system 700. Examples of these media include main memory 715, secondary memory 720 (including internal memory 725, removable storage medium 730, and external storage medium 745), and any peripheral device communicatively coupled with communication interface 740 (including a network information server or other network device). These non-transitory computer readable mediums are means for providing executable code, programming instructions, and software to the system 700.

In an embodiment that is implemented using software, the software may be stored on a computer readable medium and loaded into the system 700 by way of removable storage medium 730, I/O interface 735, or communication interface 740. In such an embodiment, the software is loaded into the system 700 in the form of electrical communication signals 820. The software, when executed by the processor 710, preferably causes the processor 710 to perform the inventive features and functions previously described herein.

The system 700 may include optional wireless communication components that facilitate wireless communication over a voice and over a data network. The wireless communication components include an antenna system 830, a radio system 840 and a baseband system 850. In the system 700, radio frequency (“RF”) signals are transmitted and received over the air by the antenna system 830 under the management of the radio system 840.

In various embodiments, the antenna system 830 may include one or more antennae and one or more multiplexors (not shown) that perform a switching function to provide the antenna system 830 with transmit and receive signal paths. In the receive path, received RF signals can be coupled from a multiplexor to a low noise amplifier (not shown) that amplifies the received RF signal and sends the amplified signal to the radio system 840.

In alternative embodiments, the radio system 840 may include one or more radios that are configured to communicate over various frequencies. In one embodiment, the radio system 840 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 840 to the baseband system 850.

If the received signal contains audio information, then baseband system 850 decodes the signal and converts it to an analog signal. Then the signal is amplified and sent to a speaker. The baseband system 850 also receives analog audio signals from a microphone. These analog audio signals are converted to digital signals and encoded by the baseband system 850. The baseband system 850 also codes the digital signals for transmission and generates a baseband transmit audio signal that is routed to the modulator portion of the radio system 840. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 830 where the signal is switched to the antenna port for transmission.

The baseband system 850 is also communicatively coupled with the processor 710. The processor 710 has access to one or more data storage areas including, for example, but not limited to, the main memory 715 and the secondary memory 720. The processor 710 is preferably configured to execute instructions (i.e., computer programs or software) that can be stored in the main memory 715 or in the secondary memory 720. Computer programs can also be received from the baseband processor 830 and stored in the main memory 715 or in the secondary memory 720, or executed upon receipt. Such computer programs, when executed, enable the system 700 to perform the various functions of the present invention as previously described. For example, the main memory 715 may include various software modules (not shown) that are executable by processor 710.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. The accompanying claims and their equivalents are intended to cover such forms or modifications as would fall within the scope and spirit of the protection. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc., are not intended to limit the order of the operations; these words are simply used to guide the reader through the description of the methods. Further, any reference to claim elements in the singular, for example, using the articles “a,” “an,” or “the” is not to be construed as limiting the element to the singular.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for storing data with a virtual file system, the method comprising:
receiving, by a processor, a file;
disassembling, by an encryption engine, the file into fragments;
encrypting, by the encryption engine, the fragments;
mapping, by the encryption engine, the fragments to different storage locations in the virtual file system;
transmitting, by the processor, the encrypted file fragments to the different storage locations in the virtual file system; and
storing the encrypted file fragments to the different storage locations in the virtual file system.

2. The method of claim 1, wherein mapping information generated by the encryption engine mapping the file fragments to the different storage locations in the virtual file system is contained in a data map.

3. The method of claim 1, wherein each file fragment is separately encrypted.

4. The method of claim 1, wherein the storage locations in the virtual file system comprise one or more of a cloud storage platform, a cloud folder, and local storage media.

5. The method of claim 1, further comprising:
organizing a plurality of virtual file systems into a cascading virtual file system; and
requiring additional credentials to access data stored in restricted levels of the cascading virtual file system.

6. The method of claim 5, further comprising restricting visibility of restricted levels of the cascading virtual file system to users having credentials allowing access to the restricted levels.

7. A method for accessing data with a virtual file system, the method comprising:
receiving, by a processor, a request to access a file;
determining, by the processor, whether the request is from an authorized user;
in response to determining that the request is from an authorized user:
retrieving, by the processor, encrypted fragments of the file from different storage locations of the virtual file system based on mapping information previously generated by an encryption engine of the fragments to the different storage locations in the virtual file system;
receiving, by the processor, the encrypted file fragments from the different storage locations in the virtual file system;
decrypting, by the encryption engine, the encrypted file fragments; and
reassembling, by the encryption engine, the decrypted file fragments into the requested file.

8. The method of claim 7, wherein the mapping information of the file fragments to the different storage locations in the virtual file system is contained in a data map.

9. The method of claim 7, further comprising:
in response to determining that the request is not by the authorized user:
logging the request into a secure audit log; and
denying access to the requested file

10. The method of claim 9, further comprising:
in response to determining that a predetermined number of unauthorized access attempts have been made, moving the encrypted file fragments to alternate storage locations in the virtual file system and updating the mapping information in the data map.

11. The method of claim 7, wherein
user access credentials for the virtual file system are stored on a remote server; and
authentication from the remote server is required to access the data in the virtual file system.

12. The method of claim 7, wherein the storage locations in the virtual file system comprise one or more of a cloud storage platform, a cloud folder, and local storage media.

13. The method of claim 7, further comprising:
organizing a plurality of virtual file systems into a cascading virtual file system; and
requiring additional credentials to access data stored in restricted levels of the cascading virtual file system.

14. The method of claim 13, further comprising restricting visibility of restricted levels of the cascading virtual file system to users having credentials allowing access to the restricted levels.

15. A non-transitory computer readable medium having stored therein a program for making a computer execute a method for storing data with a virtual file system, the program including computer executable instructions for performing operations comprising:
receiving, by a processor, a file;
disassembling, by an encryption engine, the file into fragments;
encrypting, by the encryption engine, the fragments;
mapping, by the encryption engine, the fragments to different storage locations in the virtual file system;
transmitting, by the processor, the encrypted file fragments to the different storage locations in the virtual file system; and
storing the encrypted file fragments to the different storage locations in the virtual file system.

16. The non-transitory computer readable medium having stored therein a program as defined in claim 15, wherein mapping information generated by the encryption engine mapping the file fragments to the different storage locations in the virtual file system locations is contained in a data map.

17. The non-transitory computer readable medium having stored therein a program as defined in claim 15, the program further comprising instructions to perform operations comprising:
organizing a plurality of virtual file systems into a cascading virtual file system; and
requiring additional credentials to access data stored in restricted levels of the cascading virtual file system.

18. The method of claim 17, further comprising restricting visibility of restricted levels of the cascading virtual file system to users having credentials allowing access to the restricted levels.

19. A non-transitory computer readable medium having stored therein a program for making a computer execute a method for accessing data with a virtual file system, the program including computer executable instructions for performing operations comprising:
receiving, by a processor, a request to access a file;
determining, by the processor, whether the request is from an authorized user;
in response to determining that the request is from an authorized user:
retrieving, by the processor, encrypted fragments of the file from different storage locations of the virtual file system based on mapping information previously generated by an encryption engine of the fragments to the different storage locations in the virtual file system;
receiving, by the processor, the encrypted file fragments from the different storage locations in the virtual file system;
decrypting, by the encryption engine, the encrypted file fragments; and
reassembling, by the encryption engine, the decrypted file fragments into the requested file.

20. The method of claim 19, wherein the mapping information of the file fragments to the different storage locations in the virtual file system is contained in a data map.

21. The method of claim 19, further comprising:
in response to determining that a predetermined number of unauthorized access attempts have been made, moving the encrypted file fragments to alternate storage locations in the virtual file system and updating the mapping information in the data map.

22. The method of claim 19, further comprising:
organizing a plurality of virtual file systems into a cascading virtual file system; and
requiring additional credentials to access data stored in restricted levels of the cascading virtual file system.

23. The method of claim 22, further comprising restricting visibility of restricted levels of the cascading virtual file system to users having credentials allowing access to the restricted levels.

24. A system for storing data with a virtual file system, the system comprising:
means for receiving a file;
means for disassembling the file into fragments;
means for encrypting the fragments;
means for mapping the fragments to different storage locations in the virtual file system;
means for transmitting the encrypted file fragments to the different storage locations in the virtual file system; and
means for storing the encrypted file fragments to the different storage locations in the virtual file system.

25. The system of claim 24, wherein the mapping information of the file fragments to the different storage locations in the virtual file system is contained in a data map.

26. A system for accessing data with a virtual file system, the system comprising:
means for receiving a request to access a file;
means for determining whether the request is from an authorized user;
in response to determining that the request is from an authorized user:
means for retrieving encrypted fragments of the file from different storage locations of the virtual file system based on mapping information previously generated by means for generating mapping information of the fragments to the different storage locations in the virtual file system;
means for receiving the encrypted file fragments from the different storage locations in the virtual file system;
means for decrypting the encrypted file fragments; and
means for reassembling the decrypted file fragments into the requested file.

27. The system of claim 26, wherein the mapping information of the file fragments to the different storage locations in the virtual file system is contained in a data map.
